(19) United States
(12) Patent Application Publication
(10) Pub. No.: US 2003/0059276 A1
(43) Pub. Date: Mar. 27, 2003

(54) Screw socket opening for receiving various tool bits

(76) Inventor: Chin Sun Chen, Taichung Hsien (TW)

Correspondence Address: Chin Sun Chen, P.O. Box 196, Fung Yung, Taichung, 420, TW

(21) Appl. No.: 09/967,340

(22) Filed: Sep. 26, 2001

(51) Int. Cl. F16B 23/00

(52) U.S. Cl. 411/403

(57) ABSTRACT

A screw driving head includes a cross-shaped socket opening and a multilobular socket opening communicating with each other for receiving Phillips driver bits and multilobular driver bits. The screw driving head may further include a socket slot communicating with the cross-shaped socket opening and the multilobular socket opening for receiving standard driver tool bits. The cross-shaped socket opening has one of two pairs of opposite inclined surfaces communicating with the socket slot of the screw driving head.

### BACKGROUND OF THE INVENTION

1. Field of the Invention

The present invention relates to a screw, and more particularly to a screw driving head having a socket opening for receiving various kinds of tool bits.

2. Description of the Prior Art

Various kinds of typical screw driving heads have been developed for receiving different driving tool bits respectively. For example, FIG. 1 shows a screw driving head including a cross-shaped socket opening 1 formed therein that may be used for receiving the typical Phillips tool bits only. FIG. 2 shows another screw driving head including a multilobular socket opening 2 formed therein that may be used for receiving the typical multilobular tool bits only, the socket lobes of the multilobular socket opening of the screw driving head include a rounded configuration. FIG. 3 shows a screw driving head similar to that shown in FIG. 2 and also including a multilobular socket opening 7 formed therein that may be used for receiving the typical multilobular tool bits only, the socket lobes of the multilobular socket opening of the screw driving head include a squared configuration.

FIGS. 4 and 5 illustrate the other screw driving heads each including a multilobular socket opening 3, 5 formed therein, and a slot 4, 6 of different lengths formed therein and communicating with the multilobular socket opening 3, 5 thereof respectively. The multilobular socket opening 3, 5 and the slots 4, 6 of the screw driving heads may be used for receiving two of the typical tool bits only, such as for receiving the typical multilobular tool bits and the standard driver tool bits only, and may not be used for receiving the other screw driver bits, such as the Phillips driver bits.

The present invention has arisen to mitigate and/or obviate the afore-described disadvantages of the conventional screw driving heads.

### SUMMARY OF THE INVENTION

The primary objective of the present invention is to provide a screw driving head including a socket opening for receiving various kinds of tool bits.

In accordance with one aspect of the invention, there is provided a screw driving head comprising a cross-shaped socket opening and a multilobular socket opening formed therein and communicating with each other for receiving Phillips driver bits and multilobular driver bits.

The cross-shaped socket opening of the screw driving head includes two pairs of opposite inclined surfaces formed in the screw driving head and perpendicular with each other for forming the cross-shaped socket opening of the screw driving head.

The multilobular socket opening of the screw driving head includes six socket flutes formed in the screw driving head for forming six socket lobes between the socket flutes of the screw driving head respectively. One pair of the opposite inclined surfaces of the screw driving head are communicating with an opposite pair of the six socket flutes of the screw driving head.

A socket slot is further provided and formed in the screw driving head and communicating with the cross-shaped socket opening and the multilobular socket opening of the screw driving head, for receiving standard driver tool bits.

One pair of the opposite inclined surfaces of the screw driving head are preferably aligned with and communicating with the socket slot of the screw driving head. One pair of opposite socket flutes of the screw driving head are also preferably aligned with and communicating with the socket slot of the screw driving head.

Further objectives and advantages of the present invention will become apparent from a careful reading of a detailed description provided hereinbelow, with appropriate reference to accompanying drawings.

### BRIEF DESCRIPTION OF THE DRAWINGS

FIGS. 1, 2, 3, 4, 5 are top plan views showing five of the typical screw driving heads;

FIG. 6 is a top plan view of a screw driving head in accordance with the present invention having a socket opening for receiving various kinds of tool bits;

FIG. 7 is a partial cross sectional view taken along lines 7-7 of FIG. 6;

FIG. 8 is a top plan view illustrating another embodiment of the screw driving head in accordance with the present invention;

FIG. 9 is a partial cross sectional view taken along lines 9-9 of FIG. 8;

FIG. 10 is a top plan view illustrating a further embodiment of the screw driving head in accordance with the present invention;

FIG. 11 is a partial cross sectional view taken along lines 11-11 of FIG. 10; and

FIGS. 12, 13, 14, 15 are top plan views similar to FIGS. 6, 8, 10, illustrating the further embodiments of the screw driving head in accordance with the present invention.

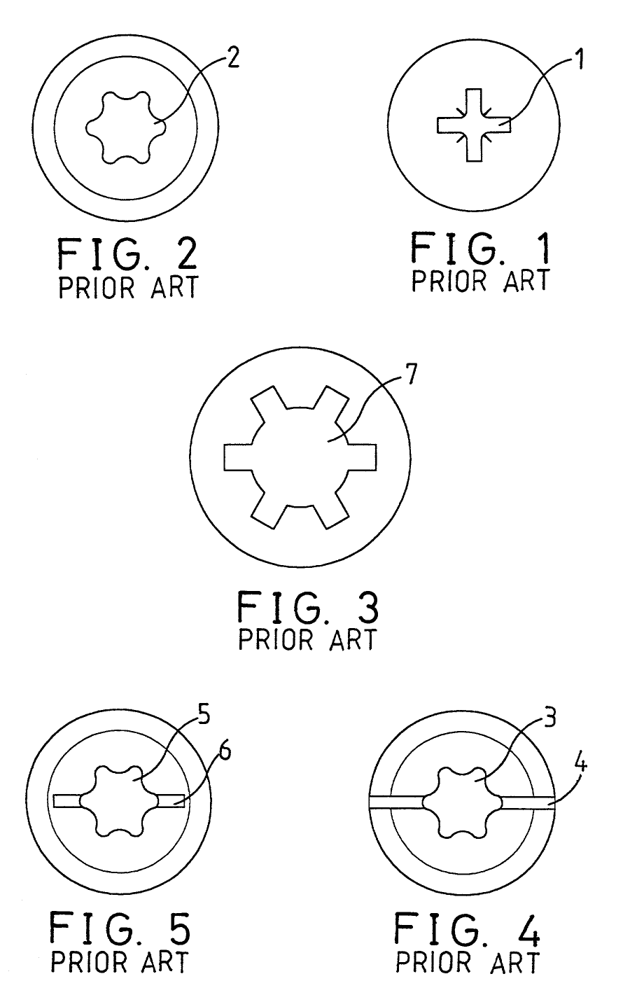

### DETAILED DESCRIPTION OF THE PREFERRED EMBODIMENT

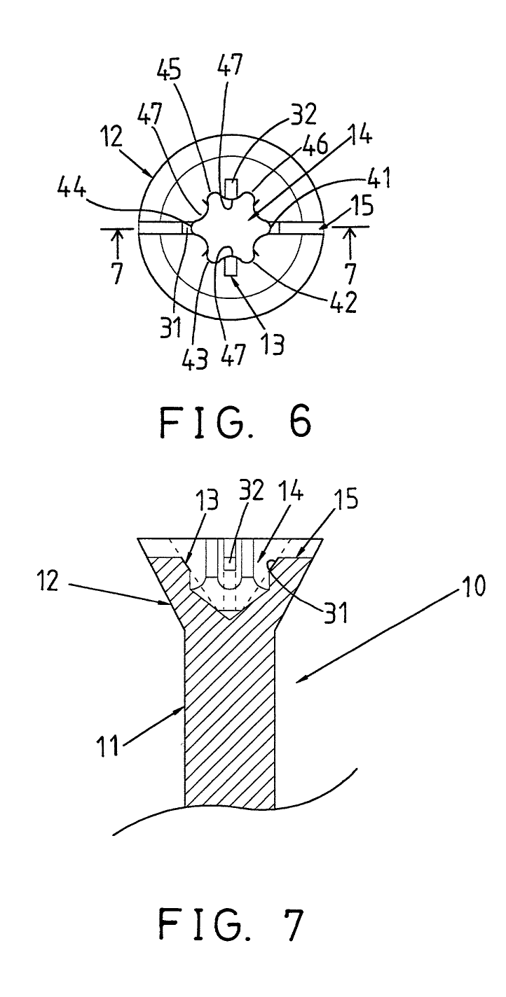

Referring to the drawings, and initially to FIGS. 6 and 7, a screw 10 in accordance with the present invention comprises a screw driver shank 11, and a screw driving head 12 formed or provided on top of the screw driver shank 11. The screw driving head 12 includes a cross-shaped socket opening 13 formed therein and formed by two pairs of opposite tapered or inclined surfaces 31, 32, for receiving the typical Phillips tool bits. The two pairs of inclined surfaces 31, 32 are perpendicular with each other when viewing from top of the screw driving head 12.

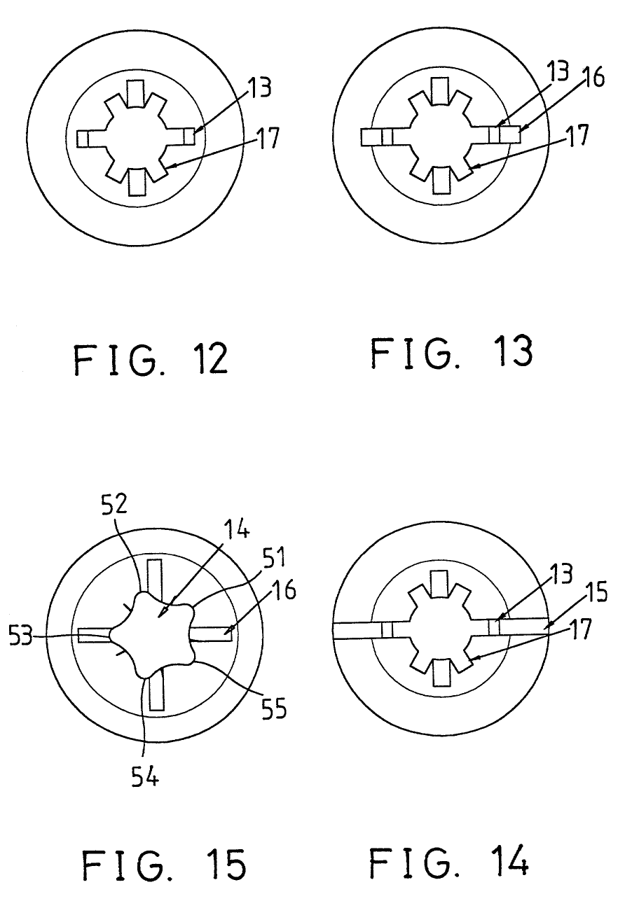

The screw driving head 12 further includes a multilobular socket opening 14 formed therein and having six socket flutes 41, 42, 43, 44, 45, 46 formed therein for forming or defining six socket lobes 47 therebetween. The multilobular socket opening 14 of the screw driving head 12 includes a depth greater than that of the cross-shaped socket opening 13, for receiving the typical multilobular tool bits. The socket flutes 41, 42, 43, 44, 45, 46 and the socket lobes 47 of the screw driving head 12 may include a rounded configuration as shown in FIGS. 6, 8, 10, and may also include a square configuration 17 as shown in FIGS. 12-14.

It is preferable that one opposite pair of the socket flutes 41, 44 of the screw driving head 12 are preferably communicating with the pair of opposite tapered or inclined surfaces 31 of the cross-shaped socket opening 13 of the screw driving head 12. The pair of opposite socket lobes 47 that are formed between the socket flutes 45, 46; and 42, 43 respectively are aligned with the other pair of opposite tapered or inclined surfaces 31 of the cross-shaped socket opening 13 of the screw driving head 12.

The screw driving head 12 further includes a socket slot 15 formed therein and communicating with or intersecting with the multilobular socket opening 14 thereof, and further communicating with the cross-shaped socket opening 13 thereof, for receiving the standard driver tool bits. For example, the socket slot 15 is aligned with and communicating with the pair of opposite tapered or inclined surfaces 31 of the cross-shaped socket opening 13 of the screw driving head 12. The socket slot 15 may includes a greater length that extends along or through the diameter of the screw driving head 12 (FIGS. 6, 7, 14), for receiving the standard driver tool bits that have a longer or greater length.

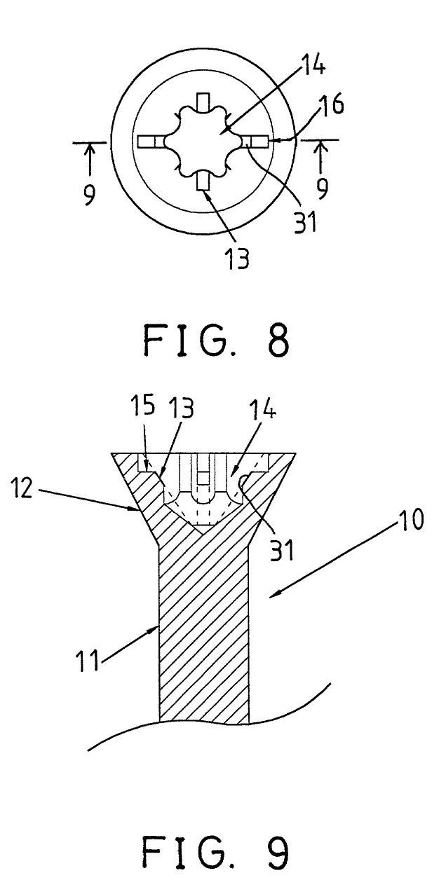

As shown in FIGS. 8 and 9, the socket slot 15 may includes a shorter length that does not extend through the diameter of the screw driving head 12, and does not extend toward the outer peripheral portion of the screw driving head 12 (FIGS. 8, 9, 13), for receiving the standard driver tool bits that have a smaller length.

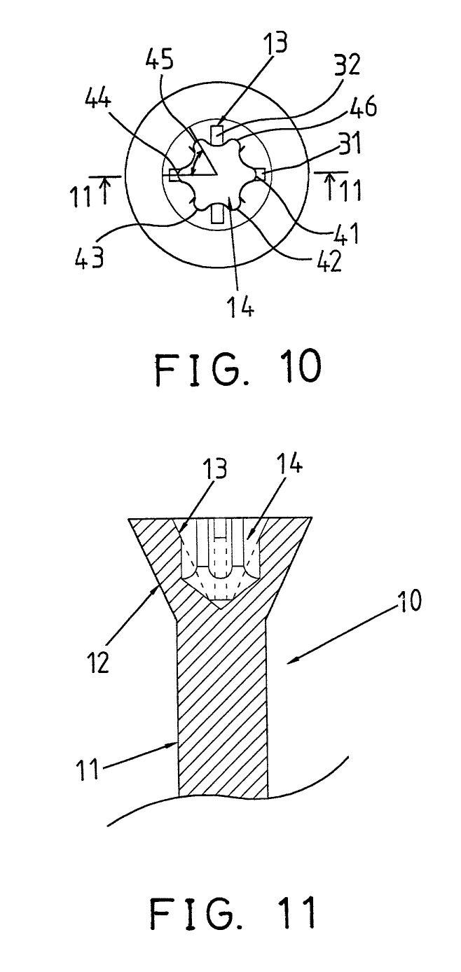

As shown in FIGS. 10, 11 and 12, without the socket slots 15, 16, the screw driving head 12 may include only the cross-shaped socket opening 13 and the multilobular socket opening 14 formed therein and communicating with each other for receiving the Phillips driver tool bits and the multilobular driver tool bits. In addition, the standard driver tool bits of less or smaller length may also be engaged into either pair of the socket flutes 41-46 of the multilobular socket opening 14 of the screw driving head 12, for driving the screw.

Referring next to FIG. 15, the screw driving head 12 may include a multilobular socket opening 14 formed therein and having five socket flutes 51, 52, 53, 54, 55 formed therein for forming or defining five socket lobes therebetween. One of the socket flutes 53 of the multilobular socket opening 14 of the screw driving head 12 is communicating with a socket slot 16 of the screw driving head 12 for receiving different driver tool bits.

Accordingly, the screw driving head in accordance with the present invention includes a socket opening for receiving various kinds of tool bits.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A screw driving head comprising:
a cross-shaped socket opening and a multilobular socket opening formed therein and communicating with each other for receiving Phillips driver bits and multilobular driver bits.

2. The screw driving head according to claim 1, wherein said cross-shaped socket opening of said screw driving head includes two pairs of opposite inclined surfaces formed in said screw driving head and perpendicular with each other for forming said cross-shaped socket opening of said screw driving head.

3. The screw driving head according to claim 1, wherein said multilobular socket opening of said screw driving head includes six socket flutes formed in said screw driving head for forming six socket lobes between said socket flutes of said screw driving head respectively.

4. The screw driving head according to claim 3, wherein said cross-shaped socket opening of said screw driving head includes two pairs of opposite inclined surfaces formed in said screw driving head and perpendicular with each other, a first pair of said opposite inclined surfaces of said screw driving head are communicating with an opposite pair of said six socket flutes of said screw driving head.

5. The screw driving head according to claim 1 further comprising a socket slot formed in said screw driving head and communicating with said cross-shaped socket opening and said multilobular socket opening of said screw driving head, for receiving standard driver tool bits.

6. The screw driving head according to claim 5, wherein said cross-shaped socket opening of said screw driving head includes two pairs of opposite inclined surfaces formed in said screw driving head and perpendicular with each other, a first pair of said opposite inclined surfaces of said screw driving head are aligned with and communicating with said socket slot of said screw driving head.

7. The screw driving head according to claim 5, wherein said multilobular socket opening of said screw driving head includes six socket flutes formed in said screw driving head for forming six socket lobes between said socket flutes of said screw driving head respectively, a pair of opposite socket flutes of said screw driving head are aligned with and communicating with said socket slot of said screw driving head.
